(19) United States
(12) Patent Application Publication
(10) Pub. No.: US 2013/0059245 A1
(43) Pub. Date: Mar. 7, 2013

(54) POLYMERIZED TONER AND PREPARATION METHOD OF THE SAME

(71) Applicants: Wook Jang, Daejeon (KR); Hak-Soo Kim, Daejeon (KR); Chang-Soon Lee, Daejeon (KR)

(72) Inventors: Wook Jang, Daejeon (KR); Hak-Soo Kim, Daejeon (KR); Chang-Soon Lee, Daejeon (KR)

(73) Assignee: LG CHEM, LTD., Seoul (KR)

(21) Appl. No.: 13/580,562

(22) PCT Filed: Feb. 22, 2011
(86) PCT No.: PCT/KR2011/001153

§ 371 Date: Nov. 13, 2012

(30) Foreign Application Priority Data
Feb. 22, 2010 (KR) 10-2010-0015895
Feb. 21, 2011 (KR) 10-2011-0015028

(51) Int. Cl. G03G 9/08; G03G 9/093; G03G 9/097; G03G 9/087; G03G 9/09

(52) U.S. Cl. 430/108.11; 430/105; 430/109.3; 430/109.1; 430/108.1; 430/108.6; 430/108.23; 430/108.21; 430/108.8; 430/108.4; 430/108.2; 430/108.5; 430/137.17; 430/137.11

(57) ABSTRACT

The present invention relates to a polymerized toner and a method for preparing the same, wherein the toner can realize an excellent offset feature, high transfer efficiency, and a uniform image and thus can exhibit excellent performances in the applications of high speed copying, development of transferred photos, etc.

### TECHNICAL FIELD

The present invention relates to a polymerized toner and a method for preparing the same. More specifically, the present invention relates to a polymerized toner and a method for preparing the same wherein the toner can realize excellent offset feature, high transfer efficiency and uniform image and thus can exhibit excellent performances in the applications of high speed copying, development of transferred photos, etc.

The present application claims priority to and the benefit of Korean Patent Application No. 10-2010-0015895 filed with the Korean Intellectual Property Office on Feb. 22, 2010, which is incorporated herein by reference in its entirety.

### BACKGROUND ART

Toners are used in the development of electronic pictures, electrostatic printers, copy machines, etc., and can be defined as paint that is capable of being transferred to and fixed on an object to form a desired pattern. As computers are more commonly used in word processing in recent years, there have been rapidly growing demands for image forming apparatuses such as printers, resulting in an increase of the amount of toners used as well.

Typically, toners are prepared by using a pulverization method or a polymerization method. The most widely known is a preparation method by using the pulverization, wherein resins and pigments are put into a melt-mixing process together, melt-mixed or extruded, and then pulverized and sorted to give toner particles. However, this method has drawbacks in that the toner particles thus obtained have a broad particle size distribution and very irregular shapes including sharpened edges resulting in inferior chargeability or flowability.

For the purpose of addressing the above-mentioned problems, a method for preparing spherical toner particles by using a polymerization method was proposed. For such a preparation method of toners by using polymerization, emulsion polymerization (coagulation method) and suspension polymerization are known in the art. The method for preparing toilers by using the suspension polymerization is preferred since the emulsion polymerization has difficulties in controlling the particle size distribution and reproducing the quality of the obtained toners.

In the suspension polymerization, the binder resin monomer and various additives including a pigment, a wax, a charge control agent, an initiator, etc. are uniformly dispersed to provide a monomer mixture, which is then dispersed in an aqueous dispersion and subjected to a polymerization reaction to give particles having a diameter of about 6 to 10 μm that is appropriate as toner particles.

The toner particles prepared by such a suspension polymerization contain some additives such as wax, etc. in order to improve the mold release property with a fixing roll during the fixing process. However, such additives may lower the quantity of electric charges on the surface of the toner to result in some problems of deteriorating the transfer efficiency or offset feature during the printing.

### CONTENTS OF THE INVENTION

### Problems to be Solved

The present invention provides a polymerized toner which can realize an excellent offset feature, high transfer efficiency, and a uniform image, and thus can exhibit excellent performances in the applications of high speed copying, development of transferred photos, etc.

The present invention also provides a method for the preparation of said polymerized toner.

### Technical Means

The present invention provides a polymerized toner which includes toner particles containing a binder resin, and a pigment, a pigment stabilizer, a charge control agent, and a wax, all of which are dispersed in said binder resin, wherein the ratio of the toner particles containing one or more wax particles within 15% of the longest diameter of the toner particles from their surfaces is 5 to 20% of the total toner particles.

In addition, the present invention provides a method for preparing the polymerized toner, which includes the steps of forming an aqueous dispersion containing a dispersant; forming a monomer mixture which includes a binder resin monomer, a pigment, a pigment stabilizer, a charge control agent, and a wax; and forming toner particles by adding the monomer to the aqueous dispersion and subjecting it to suspension polymerization, wherein the suspension polymerization includes the steps of reacting for 8 to 12 h at 50 to 70° C. , and reacting for 30 min to 4 h after raising the temperature to 80 to 100° C.

Hereinafter, the polymerized toner and preparation method of the same according to one embodiment of the invention will be explained in detail.

One embodiment of the invention provides a polymerized toner which includes toner particles containing a binder resin, and a pigment, a pigment stabilizer, a charge control agent, and a wax, all of which are dispersed in said binder resin, wherein the ratio of the toner particles containing one or more wax particles within 15% of the longest diameter of the toner particles from their surfaces is 5 to 20% of the total toner particles.

The expression “the longest diameter” as used herein means the length of the longest straight line among straight lines connecting any two points on the outermost surface of the particle and passing through the center in the circular, spherical, or similar polygonal toner particle. Also, the expression “within 15% of the longest diameter of the toner particles from their surfaces” means the region within 15% of the length of the longest diameter from the toner particle surface. Said longest diameter may be measured using an instrument such as a flow particle image analyzer (FPIA-1000, Toa Iyou Denshi K.K.), etc.

Also, the expression “containing one or more wax particles within 15% of the longest diameter of the toner particles from their surfaces” as used herein refers to the case that the outermost part of said wax particle is within said region.

It may be confirmed by observing the cross-section of the toner particle with an electron microscope whether the wax particle is within 15% of the length of the longest diameter from the toner particle surface. Also, the ratio of the toner particles containing one or more wax particles within 15% of the length of the longest diameter from the toner particle surface may be calculated from the numbers of said toner particles and the total toner particles resulting from the observation with the electron microscope.

The present inventors have confirmed that a high transfer efficiency as well as an excellent offset feature can be realized when the ratio of the toner particles containing one or more wax particles within 15%, preferably within 10%, of the longest diameter of the toner particles from their surfaces becomes 5 to 20%, preferably 7 to 17%, of the total toner particles by controlling the temperature and time of the suspension reaction during the step of preparing the polymerized toner, and completed the present invention. Also, as shown in the following examples, when the ratio of the toner particles containing one or more wax particles within 15% of the longest diameter from the toner particle surface is less than 5% or exceeds 20%, it is confirmed that the transfer efficiency is lowered or the offset feature is deteriorated.

If the ratio of the toner particles containing one or more wax particles within 15% of the longest diameter from the toner particle surface is in the range of 5 to 20%, a suitable amount of wax may exist on the surface of the toner so that the offset phenomena wherein the toner is adhered to the roll during the fixing process may be prevented, and furthermore the deterioration of chargeability on the toner surface which is caused by excess wax on the toner surface may be prevented to realize high transfer efficiency. If the ratio of the toner particles containing one or more wax particles within 15% of the longest diameter of the toner particles is less than 5%, the wax imposing the mold release property during the fixing process may not be sufficiently exposed and thus may not exhibit its ability, resulting in the deterioration of the offset feature. Also, if the ratio of said toner particles exceeds 20%, the chargeability of the toner particles may be deteriorated to cause a reduction in the transfer efficiency.

Further, in one embodiment of the invention, the toner particles may include a binder resin, and a pigment, a pigment stabilizer, a charge control agent, and wax particles, all of which are dispersed in the binder resin. Also, the toner particles may include 20 to 90 wt % of the binder resin, 1 to 20 wt % of the pigment, 2 to 30 wt % of the wax particles, 0.1 to 20 wt % of the charge control agent, and 0.1 to 20 wt % of the pigment stabilizer.

The binder resin may include a polymer of a styrene monomer, an acrylate monomer, a methacrylate monomer, a diene monomer, an acidic olefin monomer, a basic olefin monomer, or mixtures thereof. However, it is not restricted thereto, and a variety of monomers known to be used for the formation of the toner prepared by polymerization may be used without special limitation. That is, polymers or copolymers as the binder resin for the polymerized toner may be formed from such monomers.

Also, the binder resin may include a copolymer of (a) a styrene monomer; and (b) one or more monomers selected from the group consisting of an acrylate monomer, a methacrylate monomer, and a diene monomer, and the copolymer may include a product obtained from copolymerization of 30 to 95 parts by weight of the monomer (a) and 5 to 70 parts by weight of the monomer (b) with respect to 100 parts by weight of the combination of the monomer (a) and the monomer (b). Such copolymer may also be a product obtained from copolymerization of (c) one or more monomers selected from the group consisting of the acidic olefin monomer and the basic olefin monomer, together with the monomers (a) and (b). Here, the monomer (c) may be copolymerized in the amount of 0.1 to 30 parts by weight with respect to 100 parts by weight of the combination of the monomer (a) and the monomer (b).

The styrene monomer for the formation of the binder resin may include styrene, monochlorostyrene, methyl styrene, dimethyl styrene, etc., and the acrylate monomer may include methyl acrylate, ethyl acrylate, n-butyl acrylate, isobutyl acrylate, dodecyl acrylate, 2-ethylhexyl acrylate, etc. The methacrylate monomer may include methyl methacrylate, ethyl methacrylate, n-butyl methacrylate, isobutyl methacrylate, dodecyl methacrylate, 2-ethylhexyl methacrylate, etc. The diene monomer may include butadiene, isoprene, etc.

Also, an α,β-ethylene compound having a carboxylic group, etc. may be used as the acidic olefin monomer, and an aliphatic alcohol methacrylic acid ester having an amine or quaternary ammonium group, methacryl amide, vinyl amine, diallyl amine, their ammonium salts, etc. may be used as the basic olefin monomer.

The pigment includes a metal powder pigment, a metal oxide pigment, a carbon pigment, a sulfide pigment, a chromium pigment, a ferrocyanide pigment, an azo pigment, an acidic dye pigment, a basic dye pigment, a mordant dye pigment, a phthalocyanine pigment, a quinacridone pigment, a dioxane pigment, or mixtures thereof. However, the pigment is not restricted to the above, and any pigment known to be applicable to the polymerized toner may be used without special limitation.

The wax that is applied to the wax particle may include a petroleum refining wax such as paraffin wax, microcrystalline wax, ceresin wax, etc.; natural wax such as carnauba wax, etc.; synthetic wax such as polyester wax, polyethylene wax, polypropylene wax, etc., or mixtures thereof.

The charge control agent may include a cationic charge control agent, an anionic charge control agent, or mixtures thereof. As the cationic charge control agent, nigrosine dye, a higher aliphatic metal salt, an alkoxyamine, a chelate, a quaternary ammonium salt, an alkyl amide, a fluorine-treated activator, a naphthalenic acid metal salt, or mixtures thereof may be mentioned. As the anionic charge control agent, a chlorinated paraffin, a chlorinated polyester, a polyester having an acid, a sulfonylamine of copper phthalocyanine, a sulfonic acid group, or mixtures thereof may be mentioned.

Also, it is preferable to use a copolymer having a sulfonic acid group as the charge control agent, and it is more preferable to use a copolymer having a sulfonic acid group whose weight average molecular weight is between 2000 and 200,000. Still more preferably, a copolymer having a sulfonic acid group whose acid value is between 1 and 40 mg KOH/g and whose glass transition temperature is between 30 and 120° C. may be used. If the acid value is less than 1, it cannot play a role as the charge control agent. And, if the acid value is 40 or more, it may influence the interfacial properties of the monomer mixture to deteriorate the polymerization stability. If the glass transition temperature is less than 30° C., due to the low glass transition temperature of the electron control agent which is exposed on the surface, friction-melting of the toner versus toner may occur during printing to cause a blocking phenomena. And, if the glass transition temperature exceeds 120° C., the surface of the toner becomes too hard to have beneficial characteristics in coating property and fixedness. If the weight average molecular weight is less than 2000, the surface concentration may be lowered and the function of the charge control agent may not be effective due to the high compatibility with the binder resin. Further, a weight average molecular weight of 200,000 or more is not advantageous for the polymerization stability and particle size distribution, because of a viscosity increase of the monomer mixture due to the high molecular weight. As specific examples of the copolymer having a sulfonic acid group, a styrene-acrylic copolymer having sulfonic acid group, a styrene-methacrylic copolymer having a sulfonic acid group, or mixtures thereof may be mentioned, but are not limited thereto.

As the pigment stabilizer, a styrene-butadiene-styrene (SBS) copolymer having a weight average molecular weight of 2000 to 200,000 may be used. Preferably, the copolymer whose styrene to butadiene content is 10-90 to 90-10 by weight may be used. If the styrene content exceeds 90%, the block length of butadiene becomes short and thus the copolymer does not sufficiently play a role as a stabilizer due to the high compatibility with the binder resin. Further, if the styrene content is less than 10%, the copolymer sufficiently plays a role as a stabilizer but it cannot sufficiently control the action of pigment to pigment due to the short length of the styrene block. If the molecular weight is less than 2000, the copolymer cannot play a role as a pigment due to the high compatibility with the binder resin. Also, if the molecular weight is 200,000 or more, the viscosity of the monomer mixture becomes so high that the dispersion stability and polymerization stability may be deteriorated and ultimately the demerit of broadening the particle size distribution may be shown.

In addition, in one embodiment of the invention, some additives such as a reaction initiator, a cross-linking agent, a lubricant, a molecular weight control agent, a coupling agent, etc. may be further dispersed in the binder resin. The toner particles may further include 0.01 to 5 wt %, preferably 0.1 to 2 wt %, of the reaction initiator, 0.001 to 10 wt % of the cross-linking agent, or 0.001 to 8 wt % of the molecular weight control agent.

The reaction initiator may include an oil-soluble initiator and a water-soluble initiator. Specifically, azo initiators such as azobisisobutyronitrile, azobisvaleronitrile, etc.; organic peroxides such as benzoyl peroxide, lauroyl peroxide, etc.; and typically used water-soluble initiators such as potassium persulfate, ammonium persulfate, etc. may be mentioned, and mixtures of two or more selected therefrom may be used.

The cross-linking agent may include divinyl benzene, ethylene dimethacrylate, ethylene glycol dimethacrylate, diethylene glycol diacrylate, 1,6-hexamethylene diacrylate, allyl methacrylate, 1,1,1-trimethylol propane triacrylate, triallyl amine, tetraallyloxy ethane, or mixtures thereof.

The molecular weight control agent may include t-dodecyl mercaptan, n-dodecyl mercaptan, n-octyl mercaptan, carbon tetrachloride, carbon tetrabromide, or mixtures thereof.

As the lubricant and the coupling agent, any additives known to be applicable to the preparation of the polymerized toner may be used without special limitation.

On the other hand, the toner particles may further include an external additive including silica, titanium dioxide, or mixtures thereof. Such an external additive may be present in the form of a coating on the outermost part of the toner particles. The silica is preferably surface-treated with a silane compound such as dimethyldichlorosilane, dimethylpolysiloxane, hexamethyldisilazane, aminosilane, alkylsilane, octamethylcyclotetrasiloxane, etc. The titanium dioxide may be used alone or as a mixture in a rutile structure that is stable at a high temperature or an anatase structure that is stable at a low temperature, and it may have a particle size of 80 to 200 nm, preferably 100 to 150 nm.

According to other embodiment of the invention, there may be provided a method for preparing the polymerized toner which includes the steps of forming an aqueous dispersion containing a dispersant; forming a monomer mixture which includes a binder resin monomer, a pigment, a pigment stabilizer, a charge control agent, and a wax; and forming toner particles by adding the monomer to the aqueous dispersion and subjecting it to suspension polymerization, wherein the suspension polymerization includes the steps of reacting for 8 to 12 h at 50 to 70° C. , and reacting for 30 min to 4 h after raising the temperature to 80 to 100° C.

The present inventors have found that the ratio of the toner particles containing one or more wax particles within 15%, preferably within 10%, of the longest diameter of the toner particles from their surfaces may be controlled to 5 to 20%, preferably 7 to 17%, of the total toner particles if the monomer mixture dispersed in the aqueous dispersion in the form of fine liquid droplets through homogenization is subjected to the suspension polymerization reaction for 8 to 12 h at 50 to 70° C. and further reacted for 30 min to 4 h after raising the temperature to 80 to 100° C., and completed the present invention. Also, as shown in the following examples, it has been demonstrated through experiments that high transfer efficiency and excellent gloss are realized if the toner prepared by the method according to one embodiment of the invention is applied.

The method for preparing the polymerized toner may include the step of forming an aqueous dispersion containing dispersant, and such aqueous dispersion may be formed by mixing the dispersant with water. In order to homogenize the aqueous dispersion, the step of stirring or applying shearing force may be applied.

The dispersant prevents coagulation between the particles of the binder resin monomer, pigment, etc. that are present as liquid droplets in the aqueous media, and caused the particles to be uniformly dispersed. Also, the dispersant plays a role of stabilizing such liquid droplet particles through its uniform adhesion to the surface of the liquid droplet. Such a dispersant may be solubilized in the aqueous media through acid or alkali treatment, washing with warm water, etc., after completion of the polymerization reaction, and then separated from the toner particles.

The dispersant includes an inorganic dispersant, an organic dispersant, an anionic surfactant, or mixtures thereof.

Specific examples of the inorganic dispersant include calcium phosphate, calcium hydrogen phosphate, calcium dihydrogen phosphate, hydroxy apatite, magnesium phosphate, aluminum phosphate, zinc phosphate, calcium carbonate, magnesium carbonate, calcium hydroxide, magnesium hydroxide, aluminum hydroxide, calcium metasilicate, calcium sulfate, barium sulfate, bentonite, silica, alumina, mixtures thereof, etc.

Specific examples of the water soluble organic dispersant include polyvinyl alcohol, gelatin, methyl cellulose, methyl hydroxy propyl cellulose, ethyl cellulose, carboxyl methyl cellulose and its sodium salt, polyacrylic acid and its salt, starch, mixtures thereof, etc.

Specific examples of the anionic surfactant include fatty acid salts, alkyl sulfate, alkyl aryl sulfate, dialkyl sulfosuccinate, alkyl phosphate, mixtures thereof, etc.

However, the dispersant used in the method for preparing the polymerized toner is not restricted to the above, and any dispersant known to be applicable to the preparation of the polymerized toner may be used without special limitation.

The binder resin monomer, pigment, pigment stabilizer, charge control agent, wax, etc. may be mixed and dissolved thoroughly to form the monomer mixture. For the purpose of homogenization, the components may be stirred or shearing force may be applied to them.

The specific examples of the binder resin monomer, pigment, pigment stabilizer, charge control agent, and wax contained in the monomer mixture are as mentioned above. Further, the monomer mixture may include 20 to 90 wt % of the binder resin monomer, 1 to 20 wt % of the pigment, 2 to 30 wt % of the wax, 0.1 to 20 wt % of the charge control agent, and 0.1 to 20 wt % of the pigment stabilizer.

In the method for preparing the polymerized toner, the monomer mixture may be added to the aqueous dispersion to form toner particles through suspension polymerization. More specifically, the method for forming the toner particles may include the steps of adding the monomer mixture to the aqueous dispersion; applying shearing force to the aqueous dispersion and the monomer mixture to homogenize the monomer mixture in the aqueous dispersion in the form of liquid droplets; and subjecting the homogenized monomer mixture to suspension polymerization. Further, as mentioned above, the monomer mixture and aqueous dispersion may be homogenized using a homogenizer.

The monomer mixture may be uniformly dispersed in the aqueous dispersion in the form of fine water droplets (liquid droplets) to form spherical toner particles having an appropriate size. For the purpose of dispersion in the form of fine water droplets, shearing force may be applied to the monomer mixture and aqueous dispersion using a homogenizer to homogenize the solution. Specifically, the monomer mixture in the aqueous dispersion is homogenized at a rate of 5,000 to 20,000 rpm, preferably 8,000 to 17,000 rpm using a homogenizer to disperse the monomer mixture in the aqueous dispersion in the form of fine liquid droplets.

On the other hand, the method for preparing the polymerized toner may further include the steps of removing the dispersant and drying the toner particles.

The step of removing the dispersant may include the step of controlling pH to be suitable for the dissolution of the dispersant. If the dispersion wherein the toner particles are formed is controlled to have pH of 2 or less, preferably 1.5 or less, by adding a water-soluble inorganic acid such as hydrochloric acid, nitric acid, etc., the dispersant can be dissolved into the aqueous solution and removed from the toner particles. In the step of removing the dispersant, the pH is suitably controlled, the mixture is stirred for 5 h or more to sufficiently dissolve the dispersant, and then the toner slurry containing less than 50 wt % of water may be obtained using a filter. Also, the step of removing the dispersant may include the step of separating using a centrifuge. After the step of removing the dispersant, elimination of moisture using a filter and addition of excess distilled water may be repeated several times to remove the dispersant more efficiently.

The step of drying the toner particles includes the step of introducing the toner cake having no dispersant into a vacuum oven and drying it under vacuum at room temperature. However, the drying method is not limited thereto, and any drying method known to be conventionally used in the preparation step of polymerized toner may be used without special limitation.

Also, the method for preparing the polymerized toner may further include a step of coating the outside of the toner particle with an external additive. In this coating step, the surface of the toner particle may be coated with a separate external additive, for example, an inorganic powder containing silica, titanium dioxide, mixtures thereof, etc. This coating step with such an external additive may be done by adding the external additive to the toner particles and then by stirring at a high speed using a Henschel mixer. Any silica known to be applicable to the polymerized toner may be used without special limitation. The inorganic powder that is applicable to the coating step is specifically explained above, and thus the detailed explanation thereon is omitted here.

On the other hand, the step for forming the monomer mixture may include the step of further adding one or more additives selected from the group consisting of a reaction initiator, a cross-linking agent, a lubricant, a molecular weight control agent, and a coupling agent. Accordingly, in one embodiment of the invention, the monomer mixture may further include 0.01 to 5 wt % (preferably 0.1 to 2.0 wt %) of the reaction initiator, 0.001 to 10 wt % of the cross-linking agent, or 0.001 to 8.000 wt % of the molecular weight control agent. Specific examples of such reaction initiator, cross-linking agent, lubricant, molecular weight control agent, and coupling agent have already been mentioned above.

### Effect of the Invention

According to the present invention, a polymerized toner and a preparation method of the same are provided, wherein the toner can realize an excellent offset feature, high transfer efficiency, and a uniform image, and can also exhibit excellent performance in the applications of high speed copying, development of transferred photos, etc.

### BRIEF DESCRIPTION OF THE DRAWINGS

FIG. 1 represents the results of observing the toner particles according to Example 1 by TEM.

### BEST MODE FOR CARRYING OUT THE INVENTION

Hereinafter, the actions and effects of the present invention will be illustrated in more detail by means of the following examples. However, these examples are provided only to assist the understanding of the present invention and it is not intended for the scope of the present invention to be limited in any manner by them.

### Example 1

### Preparation of the Polymerized Toner

A 0.1 M aqueous sodium phosphate solution (686 g) and 1 M calcium chloride (100 g) were mixed in water (500 g) to give an aqueous dispersion wherein calcium phosphate was precipitated as crystals. The reaction temperature was raised to 70° C. and the reaction mixture was stirred for 20 min. The content of calcium phosphate in the aqueous dispersion was adjusted to 3 parts by weight with respect to 100 parts by weight of the following monomer mixture.

A binder resin monomer containing styrene (160 g), n-butyl acrylate (36 g), and acrylic acid (4 g); allyl methacrylate (4 g) as a cross-linking agent; n-dodecyl mercaptan (0.4 g) as a molecular weight control agent; a styrene-butadiene-styrene (SBS) block copolymer having a molecular weight of 10,000 (3 g) as a pigment stabilizer; and a styrene/2EHA/anionic functional monomer copolymer (Mw. 16,500, Fujikura Kasei) (4 g) as a charge control agent were mixed and thoroughly dissolved. Carbon black (10 g) was added thereto. The mixture was stirred for 2 h in a bead mill at 2000 rpm and then the beads were removed.

The mixture containing no beads was then heated to 70° C. Paraffin wax (20 g) was added and stirred for about 30 min to thoroughly dissolve the paraffin wax in the mixture. An azo nitrile initiator (V65, Wako Chemical) (5 g) was added and stirred for a further 2 min to prepare a monomer mixture. The weight of the monomer mixture was 246.4 g.

The monomer mixture was added to the aqueous dispersion, and a homogenization process was carried out by applying shearing force to the aqueous dispersion and the monomer mixture using a homogenizer at a rate of 13,000 rpm to disperse the monomer mixture in the aqueous dispersion in the form of fine liquid droplets.

The thus homogenized mixture was reacted for 10 h at 60° C. while stirring using a paddle stirrer at 200 rpm, and then further reacted for 3 h at an elevated temperature of 90° C. to give the polymerized toner.

### Washing and Drying of the Toner Particle

Hydrochloric acid was added to the aqueous dispersion containing the above polymerized toner to control pH to less than 2, and thereby calcium phosphate was dissolved. Water was removed using a filter. Then, distilled water in the amount of double the initial weight of the slurry was added to dilute and disperse, and the water was removed again. Such dilution, dispersion, and filtering processes were repeated five times to remove calcium phosphate from the surface of the toner particles.

After the moisture was finally removed by centrifugation, the toner cake was introduced into a vacuum oven and dried under vacuum for 48 h at room temperature to give the polymerized toner core. The volume average particle diameter of the resulting polymerized toner core and the ratio (standard deviation) of the volume average particle diameter to the number average particle diameter were measured to be 7 an and 1.26, respectively. Here, the volume average particle diameter of the core was measured with a Coulter counter (Multisizer 3, Beckman Coulter).

### Coating with External Additive

With respect to 100 parts by weight of the polymerized toner core, 2 parts by weight of silica was added, and the mixture was stirred at a high speed of 5000 rpm for 7 min using a Henschel mixer to coat the external additive on the surface of the polymerized toner core.

### Examples 2 to 4

The polymerized toner was prepared according to the same procedure as Example 1 except that the reaction temperature was as represented in the following Table 1.

### Comparative Examples 1 to 4

The polymerized toner was prepared according to the same procedure as Example 1 except that the reaction temperature was as represented in the following Table 1.

### Experiment

### Experiment 1: Determination of Transfer Efficiency of Toner

After feeding sections of cartridges for a laser printer (HP4600, made by Hewlett Packard) were filled with the polymerized toners prepared in Examples 1 and 2 and Comparative Examples 1 and 2, respectively, the total weight of each feeding section was determined Rectangle shapes (width: 19 cm, height: 1.5 cm) were printed on 1000 sheets of A4-sized paper and then the weights of the feeding sections were determined again and the amount of toner consumed was calculated according to the following Equation 1.

Consumed amount (g)=Weight of feeding section before 1000-sheet printing−Weight of feeding section after 1000-sheet printing Equation 1

In addition, the drum section that is detachable with the feeding section was weighed before and after printing to calculate the amount of toner that was wasted without being transferred to paper according to the following Equation 2.

Wasted amount of toner (g)=Weight of drum section after 1000-sheet printing−Weight of drum section before 1000-sheet printing Equation 2

After calculation of the consumed and wasted amounts of toner as above, the transfer efficiency was calculated according to the following Equation 3.

Transfer efficiency (%)={(Consumed amount−Wasted amount of toner)/Consumed amount}*100 Equation 3

### Experiment 2: Determination of Offset Feature

An image (width: 1 cm, length: 5 cm) was printed five times at an interval of 5 cm on a sheet of A4-sized paper with a laser printer (HP2600, made by Hewlett Packard). Then, the offset feature was evaluated by determining whether any afterimage remained on the paper at an interval of 5.7 cm, a circumference of the fixing roll, in the rectangular print. The degree of afterimage was observed with a microscope to count the number of afterimages in the form of a spot in an area of 1 cm length and 1 cm width. The offset feature was determined to be “X” when the number of spots is 20 or more, “◯” when the number is 10-20, and “⊚” when the number is less than 10.

### Experiment 3: Determination of Gloss

The front page of a sheet of A4-sized paper was printed with a laser printer (HP2600, made by Hewlett Packard). Then, the gloss was measured using a gloss meter (RD918, Macbeth).

As for the polymerized toners prepared according to Examples 1˜3 and Comparative Examples 1˜4, the results of evaluation on the average particle diameter, ratio of toner particles containing one or more wax particles within 0.15d (% with respect to the total number of toner particles), transfer efficiency, offset feature, and gloss are represented in the following Table 1.

Here, the diameter (d) of the toner particles and the ratio of the toner particles containing one or more wax particles within 15% of the longest diameter of the toner particles from their surfaces were obtained using a transmission electron microscope (TEM). If the outermost part of said wax particle existed within 15% of the longest diameter from the surface of the toner particle, the wax particle was determined to be contained within said region.

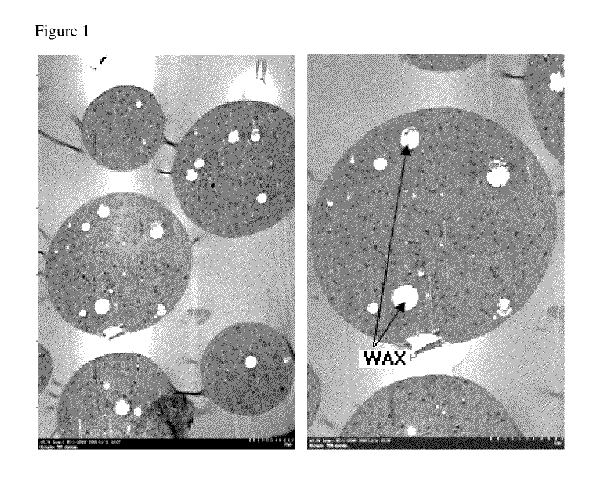

The results of observing the toner particle according to Example 1 by TEM is shown in FIG. 1.

TABLE 1
Results of Experiments 1 to 3

| | | | Ratio of | | |
|---|---|---|---|---|---|
| | | | toner | | |
| | | | particles | | |
| | | | containing | | |
| | | | one or more | | |
| | 60° C. | 90° C. | wax particles | Transfer | |
| | Reaction | Reaction | within | Efficiency | Offset |
| | Time (h) | Time (h) | 0.15d (%) | (%) | Feature |
| Example 1 | 10 | 3 | 20 | 95 | ⊚ |
| Example 2 | 10 | 1 | 10 | 96 | ◯ |
| Example 3 | 10 | 2 | 15 | 95 | ⊚ |
| Example 4 | 10 | 0.7 | 7 | 96 | ◯ |
| Comparative | 10 | — | 2 | 96 | X |
| Example 1 | | | | | |
| Comparative | 10 | 10 | 40 | 80 | ⊚ |
| Example 2 | | | | | |
| Comparative | 10 | 5 | 27 | 85 | ⊚ |
| Example 3 | | | | | |
| Comparative | 10 | 7 | 30 | 75 | ⊚ |
| Example 4 | | | | | |

* d means the longest diameter of the toner particle

The results of the above [Table 1] confirm that the transfer efficiency is improved and the gloss and offset feature become excellent when the ratio of the toner particles containing one or more wax particles within 15% of the longest diameter of the toner particles from their surfaces is 5 to 20% of the total toner particles.

1. A polymerized toner which comprises toner particles containing a binder resin, and a pigment, a pigment stabilizer, a charge control agent, and a wax, all of which are dispersed in said binder resin, wherein the ratio of toner particles containing one or more wax particles within 15% of the longest diameter of the toner particles from their surfaces is 5 to 20% of the total toner particles.

2. The polymerized toner according to claim 1, wherein the ratio of the toner particles containing one or more wax particles within 10% of the longest diameter of the toner particles from their surfaces is 7 to 17% of the total toner particles.

3. The polymerized toner according to claim 1, wherein the toner particles comprise 20 to 90 wt % of the binder resin, 1 to 20 wt % of the pigment, 2 to 30 wt % of the wax particles, 0.1 to 20 wt % of the charge control agent, and 0.1 to 20 wt % of the pigment stabilizer.

4. The polymerized toner according to claim 1, wherein the binder resin comprises a polymer of one or more selected from the group consisting of a styrene monomer, an acrylate monomer, a methacrylate monomer, a diene monomer, an acidic olefin monomer, and a basic olefin monomer.

5. The polymerized toner according to claim 1, wherein the binder resin comprises a copolymer of (a) a styrene monomer and (b) one or more monomers selected from the group consisting of an acrylate monomer, a methacrylate monomer, and a diene monomer.

6. The polymerized toner according to claim 5, wherein the copolymer is obtained from copolymerization of 30 to 95 parts by weight of the monomer (a) and 5 to 70 parts by weight of the monomer (b), with respect to 100 parts by weight of the combination of the monomer (a) and the monomer (b).

7. The polymerized toner according to claim 4, wherein the copolymer is obtained from the copolymerization of (a) a styrene monomer, (b) one or more monomers selected from the group consisting of an acrylate monomer, a methacrylate monomer, and a diene monomer, and (c) one or more monomers selected from the group consisting of an acidic olefin monomer and a basic olefin monomer.

8. The polymerized toner according to claim 7, wherein the monomer (c) is copolymerized in the amount of 0.1 to 30 parts by weight with respect to 100 parts by weight of the combination of the monomer (a) and the monomer (b).

9. The polymerized toner according to claim 1, wherein the pigment comprises one or more selected from the group consisting of a metal powder pigment, a metal oxide pigment, a carbon pigment, a sulfide pigment, a chromium pigment, a ferrocyanide pigment, an azo pigment, an acidic dye pigment, a basic dye pigment, a mordant dye pigment, a phthalocyanine pigment, a quinacridone pigment, and a dioxane pigment.

10. The polymerized toner according to claim 1, wherein the wax particle comprises one or more wax particles selected from the group consisting of paraffin wax, microcrystalline wax, ceresin wax, carnauba wax, polyester wax, polyethylene wax, and polypropylene wax.

11. The polymerized toner according to claim 1, wherein the charge control agent comprises one or more cationic charge control agents selected from the group consisting of a nigrosine dye, a higher aliphatic metal salt, an alkoxyamine, a chelate, a quaternary ammonium salt, an alkyl amide, a fluorine-treated activator, and a naphthalenic acid metal salt; or one or more anionic charge control agents selected from the group consisting of a chlorinated paraffin, a chlorinated polyester, a polyester having an acid, a sulfonylamine of copper phthalocyanine, and a styrene-acrylic polymer having a sulfonic acid group.

12. The polymerized toner according to claim 1, wherein the charge control agent comprises a copolymer having a sulfonic acid group whose weight average molecular weight is 2000 and 200,000, acid value is 1 to 40 mg KOH/g, and glass transition temperature is 30 to 120° C.

13. The polymerized toner according to claim 1, wherein the pigment stabilizer comprises a styrene-butadiene-styrene block copolymer having a weight average molecular weight of 2000 to 200,000.

14. The polymerized toner according to claim 1, wherein one or more additives selected from the group consisting of a reaction initiator, a cross-linking agent, a lubricant, a molecular weight control agent, and a coupling agent are further dispersed in the binder resin.

15. A method for preparing a polymerized toner, which comprises the steps of:
forming an aqueous dispersion containing a dispersant;
forming a monomer mixture which comprises a binder resin monomer, a pigment, a pigment stabilizer, a charge control agent, and a wax; and
forming toner particles by adding the monomer mixture to the aqueous dispersion and subjecting it to suspension polymerization,
wherein the suspension polymerization comprises the steps of reacting for 8 to 12 h at 50 to 70° C. , and reacting for 30 min to 4 h after raising the temperature to 80 to 100° C.

16. The method for preparing a polymerized toner according to claim 15, wherein a ratio of the toner particles containing one or more wax particles within 15% of the longest diameter of the toner particles from their surfaces is 5 to 20% of the total toner particles.

17. The method for preparing a polymerized toner according to claim 15, wherein a ratio of the toner particles containing one or more wax particles within 10% of the longest diameter of the toner particles from their surfaces is 7 to 17% of the total toner particles.

18. The method for preparing a polymerized toner according to claim 15, wherein the step for forming the toner particles comprises the steps of:
adding the monomer mixture to the aqueous dispersion;
applying shearing force to the aqueous dispersion and the monomer mixture to homogenize the monomer mixture in the aqueous dispersion in the form of liquid droplets; and
subjecting the homogenized monomer mixture to suspension polymerization.

19. The method for preparing a polymerized toner according to claim 15, which further comprises the steps of removing the dispersant and drying the toner particles.

20. The method for preparing a polymerized toner according to claim 15, which further comprises a step of coating the outside of the toner particle with an external additive.

21. The method for preparing a polymerized toner according to claim 15, wherein the dispersant comprises one or more selected from the group consisting of an inorganic dispersant, a water soluble organic polymer dispersant, and an anionic surfactant.

22. The method for preparing a polymerized toner according to claim 15, wherein the monomer mixture further comprises one or more additives selected from the group consisting of a reaction initiator, a cross-linking agent, a lubricant, a molecular weight control agent, and a coupling agent.
